(19) United States
(12) Patent Application Publication
(10) Pub. No.: US 2013/0239366 A1
(43) Pub. Date: Sep. 19, 2013

(54) COUPLING STRUCTURE OF GLASSES FRAMES AND GLASSES LEGS

(71) Applicant: Young Ho Kim, Gyeongsan-si (KR)

(72) Inventor: Young Ho Kim, Gyeongsan-si (KR)

(21) Appl. No.: 13/989,591

(22) PCT Filed: Nov. 25, 2011
(86) PCT No.: PCT/KR11/09062

§ 371 Date: May 24, 2013

(30) Foreign Application Priority Data
Nov. 26, 2010 (KR) 10-2010-011424
Nov. 23, 2011 (KR) 10-2011-0122890

(51) Int. Cl. G02C 5/22

(52) U.S. Cl. CPC G02C 5/2254
USPC 16/228

(57) ABSTRACT

The present invention relates to a coupling structure of glasses frames and glasses legs in which the frames and the legs can be easily coupled or uncoupled to/from each other, which enables lenses to be easily coupled to the frames, and which provides elasticity when the legs are folded or unfolded. The coupling structure of the present invention includes: a hinge piece tightly inserted between end pieces split at a distal end of the frames such that the hinge piece protrudes, wherein the hinge piece has a stopper groove; an elastic member having a slot for the insertion of the hinge piece; and legs having a rotation pin and an operating slot such that a front end of the legs can be fitted into the stopper groove while elastically pressing the elastic member.

### TECHNICAL FIELD

The present invention relates to a coupling structure of glasses frames and glasses legs, and more particularly, to a coupling structure of glasses frames and glasses legs, in which the frames and the legs can be easily coupled or uncoupled to/from each other, which enables lenses to be easily coupled to the frames, and which provides elasticity when the legs are folded or unfolded.

### BACKGROUND ART

In general, frames of eyeglasses consists of lenses coupling frames and temple bars that are legs rotatably coupled to an end piece of the frames, in which the frames and temple bars are manufactured of as a plastic or metal material.

The frames and legs that consist of the frames are typically coupling with screws and configured to be folded or unfolded, and include elastic means to make it easier to fold or unfold by applying elasticity when folded or unfolded.

Of course, the elastic means are installed to the legs in a complex structure, and the legs are coupled to the frames with screws, and thus they are not easily separated.

### DETAILED DESCRIPTION OF THE INVENTION

### Technical Problem

However, as mentioned above, if glasses frames and legs are used by being coupled with screws, an operation of fitting a lens into the frames is complex, and a structure of applying elasticity to the legs is too complex to manufacture, which problematically causes a reduction in manufacturing efficiency.

Therefore, to solve the above problem, the present invention provides a coupling structure of glasses frames and glasses legs, which facilitates assembly and removal of the frames, provides elasticity when the legs are folded and unfolded, and maximizes manufacturing efficiency of the frames.

### Technical Solution

According to an aspect of the present invention, there is provided a coupling structure of glasses frames and glasses legs including a hinge piece tightly inserted between end pieces split at a distal end of the frames such that the hinge piece protrudes, wherein the hinge piece has a stopper groove; an elastic member having a slot for the insertion of the hinge piece; and legs having a rotation pin and an operating slot such that a front end of the legs can be fitted into the stopper groove while elastically pressing the elastic member.

According to another aspect of the present invention, there is provided a coupling structure of glasses frames and glasses legs including: a hinge piece protruding from the inside of an end piece integrally formed with an end of the frames by synthetic-resin injection-molding, wherein the hinge piece has a stopper groove; an elastic member having an upper plate and a lower plate, wherein an intermediate portion of the upper plate is elastically bent, the upper plate and the lower plate have respective slots to be doubly fitted onto the hinge piece, and the intermediate portion of the upper plate is bent at a predetermined angle to form a protrusion in the horizontal direction; and a leg, the front end of which has a rotation pin such that the front end of the leg can be fitted into the stopper groove of the hinge piece while elastically pressing the upper plate of the elastic member, wherein the leg has a relatively vertically elongate operating slot at the front end thereof such that the legs is rotatable about the rotation pin.

### Advantageous Effects

As mentioned above, the present invention relates to assembly of glasses frames by fitting an elastic member and glasses legs into hinge pieces formed in end pieces of the frames, which is easy to assemble and disassemble the frames and accordingly improves the manufacturing efficiency of the frames.

### DESCRIPTION OF THE DRAWINGS

FIG. 1 is an exploded perspective view of a coupling structure of glasses frames and glasses legs according to an embodiment of the present invention;

FIG. 2 is an assembled perspective view of a coupling structure of glasses frames and glasses legs according to an embodiment of the present invention;

FIG. 3 is an enlarged view of a folded state of glasses legs according to an embodiment of the present invention;

FIG. 4 is a cross-sectional view of an unfolded state of glasses legs according to an embodiment of the present invention;

FIG. 5 is an exploded perspective view of a second embodiment of the present invention in which a stopper groove is different;

FIG. 6 is an assembled perspective view of the second embodiment of the present invention;

FIG. 7 is an enlarged view of a folded state of glasses legs according to the second embodiment of the present invention;

FIG. 8 is a cross-sectional view of an unfolded state of glasses legs according to the second embodiment of the present invention;

FIG. 9 is an exploded perspective view of a third embodiment of the present invention in which glasses frames are different;

and

FIG. 10 is an exploded perspective view of a fourth embodiment of the present invention in which a hinge piece of the third embodiment is different.

Explanation of Reference Numerals

| | |
|---|---|
| 1: stopper groove | 2: hinge piece |
| 3: slot | 3-1: slot of lower plate |
| 3-2: slot of upper plate | 4: elastic member |
| 5: operating slot | 6: protrusion |
| 7: leading portion | 8: rotation pin |

### MODE OF THE INVENTION

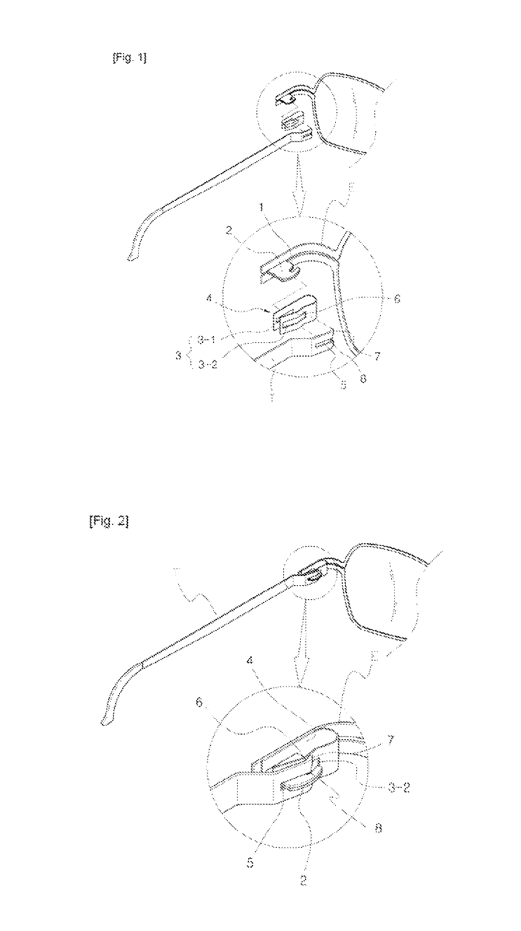

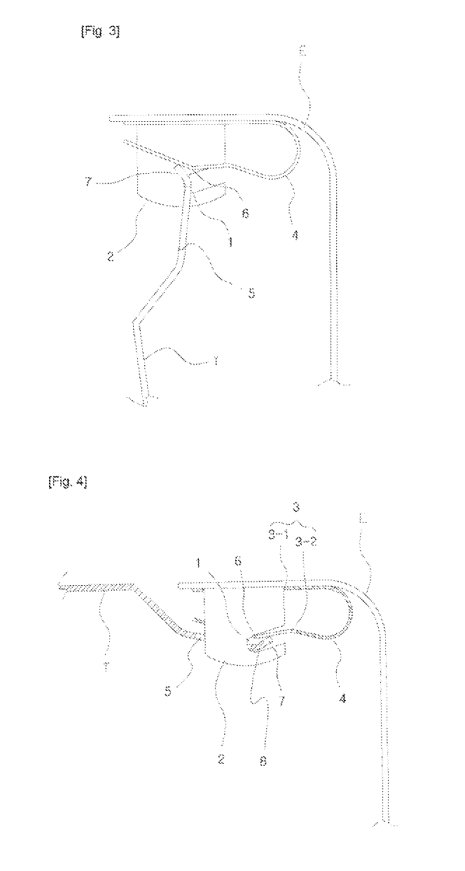

As shown in FIGS. 1 through 4, the present invention provides a hinge piece (2) tightly inserted between end pieces (E) split at a distal end of the frames such that the hinge piece (2) protrudes, wherein the hinge piece (2) has a stopper groove (1); an elastic member (4) having an upper plate and a lower plate, wherein an intermediate portion of the upper plate is elastically bent, the upper plate and the lower plate have respective slots (3) to be doubly fitted onto the hinge piece (2), and the intermediate portion of the upper plate is bent at a predetermined angle to form a protrusion (6) in the horizontal direction; and a leg (T), the front end of which has a rotation pin (8) such that the front end of the leg (T) can be fitted into the stopper groove (1) of the hinge piece (2) while elastically pressing the upper plate of the elastic member (4), wherein the leg (T) has a relatively vertically elongate operating slot (5) at the front end thereof such that the legs (T) is rotatable about the rotation pin (8).

In this regard, the elastic member (4) is bent with the middle of a long formed plate material having elasticity so that the slots 3 are respectively formed in the upper plate of a top portion and the lower plate of a bottom portion, in which a lower plate slot 3-1 is formed to allow the split hinge piece 2 to be tightly inserted so that the hinge piece 2 can be fixed, and an upper plate slot 3-2 is formed to be slightly larger than the hinge piece 2 so that the hinge piece 2 can be easily inserted and separated.

That is, the slot 3-1 of the lower plate of the bottom portion functions to fix the hinge piece 2.

The hinge piece 2 is respectively in each of the split end pieces E and is in close contact with the end pieces E when closely contacting the end pieces E.

Also, protrusions 6 that are bent at a predetermined angle in the middle of both sides of the upper plate slot 3-2 are formed in the elastic member 4 to give intermittent when the leg T is folded or unfolded. A leading portion 7 that moves along the protrusion 6, gives intermittent when the leg T is folded or unfolded at a certain angle, and is bent at a predetermined angle is formed on a leading part of the leg T.

That is, when the leg T is folded or unfolded, if the leading portion 7 moves along the protrusion 6 at an angle greater than a certain angle, the leg T is rapidly folded or unfolded due to an action of a spring force.

In particular, the stopper groove 1 of the hinge piece 2 is formed to have an entrance disposed downward rather than inward in which the rotation pin 8 is disposed so that the rotation pin 8 of the leg T may not be removed when fitted into the stopper groove 1.

In the above-described present invention, if the elastic member 4 is fitted into the hinge piece 2, the lower plate slot 31 is first fitted and is seated in the end piece E, and the upper plate slot 3-2 is fitted into an upper end portion of the hinge piece 2 so that the elastic member 4 may elastically move up and down. In this state, if an upper plate of the elastic member 4 is pressed toward the leading portion 7 of the leg T, the slot 1 of the hinge piece 2 is exposed above the upper plate. If the rotation pin 8 is inserted into the stopper groove 1 in a state where the hinge piece 2 passes through between the operating slot 5 of the leg T, the leg T is rotatably movable with respect to the rotation pin 8 and the stopper groove 1.

Also, in the present invention, if the leg T rotatably moves, when the leading portions 7 protruding from both sides of the rotation pin 8 pass the protrusions 6 of the upper plate of the elastic member 4, the spring force rapidly increases and decreases, and thus the leg T is rapidly folded or unfolded. Since a direction of the spring force influencing the leading portion 7 of the leg T is changed by passing the protrusions 6, a force resisting to fold or unfold the leg T is applied before passing the protrusions 6, and an elastic force to fold or unfold the leg T is applied after passing the protrusions 6 so that a state in which the leg T is folded or unfolded is maintained.

In particular, an operation of coupling the leg T to the glasses frame merely inserts the rotation pin 8 of the leg T into the stopper groove 1 having the entrance exposed by merely fitting and pressing the elastic member 4 into the hinge piece 2, thereby very simply and effectively assembling the glasses frame.

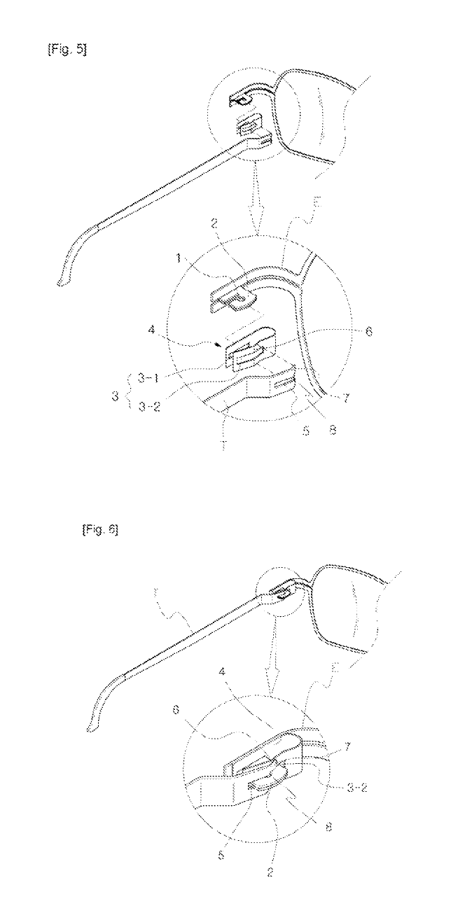

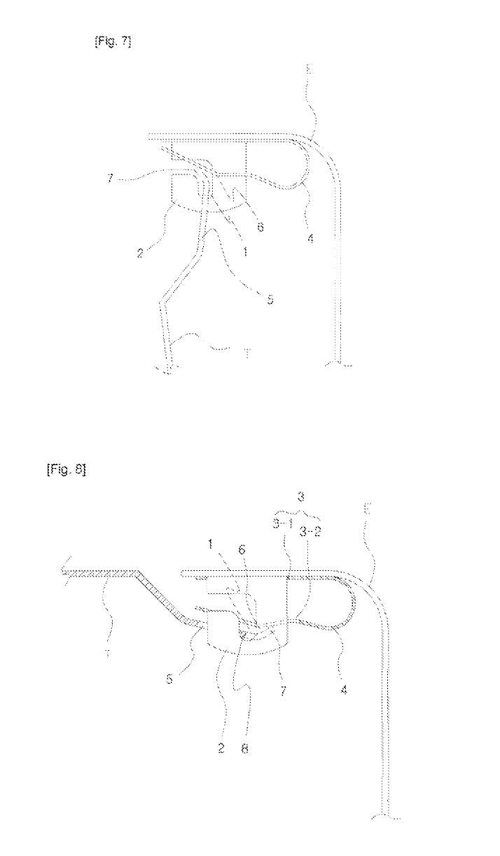

Meanwhile, in the present invention, as shown in FIGS. 1 through 4, the entrance of the stopper groove 1 formed in the hinge piece 2 is formed forward the glasses such that the rotation pin 8 of the leg T may be fitted in the front of the hinge piece 2. As shown in FIGS. 5 through 8, the entrance of the stopper groove 1 formed in the hinge piece 2 is formed backward the glasses such that the rotation pin 8 of the leg T may be fitted in the rear of the hinge piece 2.

In particular, in a case of the embodiment in which the entrance of the stopper groove 1 is formed to open backward, the entrance of the stopper groove 1 may be formed closer to a lower end of the hinge piece 2 than inward of the stopper groove 1 in which the rotation pin 8 is disposed such that the rotation pin 8 of the leading part of the leg T engaged into the stopper groove 1 is not easily escaped.

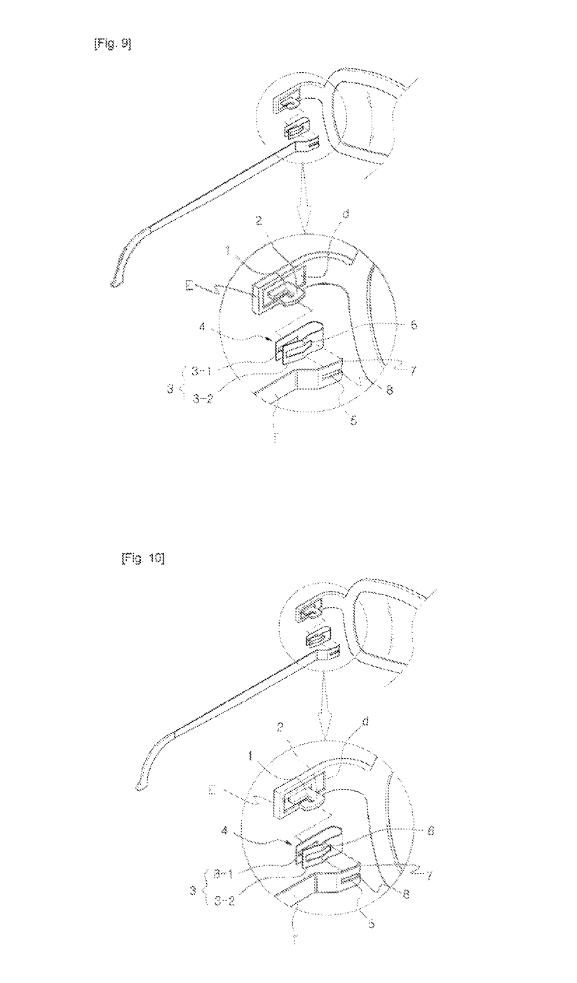

Meanwhile, FIG. 9 shows another embodiment of the present invention in which glasses frames are formed in a synthetic resin injection. The end piece E and the hinge piece 2 can be integrally formed by injection, and a groove d is formed around the hinge piece 2 in an inner side of the end piece E.

In the above-described other embodiment of the present invention, the elastic member 4 is fitted into the hinge piece 2 by the stopper groove 3 so that a lower plate of the elastic member 4 is fitted into the groove d of the end piece E.

Also, FIG. 10 shows another embodiment in which the hinge piece 2 is formed of metal in the above other embodiment of the present invention, in which a coupling groove is formed in the end piece E during injection, a stopper protrusion is formed in a lower end of the hinge piece 2 so that the hinge piece 2 may be coupled by pressing the hinge piece 2 into the coupling groove after injection, and the lower end of the hinge piece 2 maybe buried with injection resin and coupled to the end piece E during injection of the glasses frame.

In the above-described other embodiments of the present invention, the end piece E and the hinge piece 2 of the glasses frame are integrally formed and thus a joint part of the leg T is not disconnected.

1. A coupling structure of glasses frames and glasses legs comprising:
a hinge piece (2) tightly inserted between end pieces (E) split at a distal end of the frames such that the hinge piece (2) protrudes, wherein the hinge piece (2) has a stopper groove (1); an elastic member (4) having a slot (3) for the insertion of the hinge piece (2); and legs (T) having a rotation pin (8) and an operating slot (5) such that a front end of the legs (T) can be fitted into the stopper groove (1) while elastically pressing the elastic member (4).

2. The coupling structure of glasses frames and glasses legs of claim 1, wherein the elastic member (4) is bent with the middle of a long formed plate material having elasticity so that the slots (3) are respectively formed in the upper plate of a top portion and the lower plate of a bottom portion.

3. The coupling structure of glasses frames and glasses legs of claim 1, wherein protrusions (6) that are bent are formed in the middle of the upper plate of the elastic member (4).

4. The coupling structure of glasses frames and glasses legs of claim 1, wherein an entrance of the stopper groove (1) of the hinge piece (2) is formed to open forward.

5. The coupling structure of glasses frames and glasses legs of claim 1, wherein an entrance of the stopper groove (1) of the hinge piece (2) is formed to open backward.

6. A coupling structure of glasses frames and glasses legs comprising:
a hinge piece (2) protruding from the inside of an end piece (E) integrally formed with an end of the frames by synthetic-resin injection-molding, wherein the hinge piece (2) has a stopper groove (1); an elastic member (4) having an upper plate and a lower plate, wherein an intermediate portion of the upper plate is elastically bent, the upper plate and the lower plate have respective slots (3) to be doubly fitted onto the hinge piece (2), and the intermediate portion of the upper plate is bent at a predetermined angle to form a protrusion (6) in the horizontal direction; and legs (T), the front end of which has a rotation pin (8) such that the front end of the legs (T) can be fitted into the stopper groove (1) of the hinge piece (2) while elastically pressing the upper plate of the elastic member (4), wherein the leg (T) has a relatively vertically elongate operating slot (5) at the front end thereof such that the legs (T) is rotatable about the rotation pin (8).

7. The coupling structure of glasses frames and glasses legs of claim 6, wherein the hinge piece (2) is formed of metal so that a lower end of the hinge piece (2) is configured to be coupled to the end piece (E) of the leg (T) during an injection.

8. The coupling structure of glasses frames and glasses legs of claim 6, wherein the hinge piece (2) is formed of the same synthetic resin during an injection of the leg (T).

9. The coupling structure of glasses frames and glasses legs of claim 6, wherein the hinge piece (2) is coupled by using a pressing method after an injection of the leg (T).
